(19) United States
(12) Patent Application Publication
(10) Pub. No.: US 2026/0188859 A1
(43) Pub. Date: Jul. 2, 2026

(54) SIMPLE AND MODULAR ASSEMBLY OF BATTERY CELLS USING PRINTED CIRCUIT BOARDS

(71) Applicant: JOHN COCKERILL DEFENSE SA, Loncin (BE)

(72) Inventors: Maxime JAVAUX, Plainevaux (BE); Ronny TITS, Riemst (BE)

(21) Appl. No.: 19/129,339

(22) PCT Filed: Nov. 6, 2023
(86) PCT No.: PCT/EP2023/080811

§ 371 Date: May 13, 2025

(30) Foreign Application Priority Data
Nov. 18, 2022 (EP) 22208379.2

(51) Int. Cl. H01M 50/519; H01M 10/42; H01M 50/213; H01M 50/291; H01M 50/293; H01M 50/507; H01M 50/514

(52) U.S. Cl. CPC H01M 50/519; H01M 10/425; H01M 50/213; H01M 50/291; H01M 50/293; H01M 50/507; H01M 50/514; H01M 2010/4271

(57) ABSTRACT

A rechargeable battery pack includes: a plurality of battery cells, each battery cell of the plurality of battery cells having a positive terminal and a negative terminal, an upper surface and a lower surface, the positive and negative terminals being arranged on a same side on the upper or lower surface or alternatively arranged on the upper and lower surface, the plurality of battery cells being arranged in a first direction and in a second direction, orthogonal to the first direction; a mechanical support structure for the battery cells; at least two printed circuit boards for electrical interconnection of the battery cells arranged on the upper surface or the lower surface, or both; and means of electrical interconnection by contact and without welding between the battery cells and the printed circuit boards allowing a connection of the battery cells in series and/or in parallel.

### CROSS-REFERENCE TO PRIOR APPLICATIONS

This application is a U.S. National Phase application under 35 U.S.C. § 371 of International Application No. PCT/EP2023/080811, filed on Nov. 6, 2023, and claims benefit to European Patent Application No. EP 22208379.2, filed on Nov. 18, 2022. The International Application was published in French on May 23, 2024 as WO/ 2024/104804 under PCT Article 21(2).

### FIELD

The present invention falls within the field of electrical energy storage in batteries. the invention relates more particularly to the design of battery packs comprising a relatively high number of small-sized battery cells.

### BACKGROUND

Currently, the unit cells that constitute the basic elements of a battery are generally welded together or connected by metal plates screwed together. Welding implies that cells, notably defective cells, cannot be easily removed individually from the battery pack for maintenance or recycling. To prevent the cells from being bonded together only by welds, the use of glue is also very common, which allows to stabilize the cells and protect them against vibration.

The protection and low-level integrity (which therefore does not concern the BMS —battery management system) of the battery is often achieved by a small wire soldered between the head of each unit cell and a bus bar to act as a fuse in case of malfunction of the concerned unit cell. The fuse must be specifically sized to match the electrical characteristics of the unit cells, and the entire assembly is impacted if a standard unit cell, mechanically identical but electrically different, is used.

In the case of a wire fuse, there is the disadvantage that this fuse, once burned or broken, causes a short circuit on one of the cells of the battery pack or that metal particles are released into the battery pack. When the fuse is integrated into a printed circuit board (see below), it, on the contrary, retains its physical integrity in case of destruction.

According to the known state of the art, to summarize, a battery pack is mainly presented in the form of an assembly via spot welding directly on the cells or via welding of a sheet and/or a fuse wire if a fuse is provided. To ensure the mechanical integrity of the battery pack, different glues are generally used to bond the cells together.

The current approach presents the major drawback of offering only insufficient possibilities in terms of maintenance, recycling, and flexibility since it is extremely difficult, if not impossible, to unweld and remove the glue without damaging the battery pack.

In the current technique, a completely new design must be made each time a new battery pack is created, due to a lack of flexibility. Maintenance is almost impossible, and recycling is difficult.

Document U.S. Pat. No. 11,302,981B2 discloses a battery pack comprising a plurality of battery cells, each battery cell having a positive electrode and a negative electrode on an upper surface of the battery cell, the battery cells being arranged in a first direction and in a second direction crossing the first direction; a circuit protection module, the circuit protection module comprising a printed circuit board (PCB) arranged on the battery cells, and a plurality of conductive tabs on the printed circuit board allowing electrical connection of the battery cells; and a casing accommodating the battery cells and the circuit protection module; in which, each of the conductive tabs comprises a substrate connector connected to the printed circuit board, a cell connector electrically connected to a battery cell, and a fuse link extending from the substrate connector and having a width less than that of the substrate connector.

Document U.S. Pat. No. 10,720,616B2 discloses a battery pack that comprises: a plurality of battery cells; a printed circuit board (PCB) substrate electrically connected to the plurality of battery cells and comprising first and second surfaces opposite each other; and first and second electrode tabs electrically connecting each of the battery cells and the PCB substrate and respectively connected to conductive pads that have different polarities and are located on the first surface of the PCB substrate. The battery pack has an improved structure for easy electrical connection of the battery cells.

Document US20160329606A1 discloses a battery pack having a casing that comprises housing zones for the battery cells located between the printed circuit boards (PCBs). Each PCB has openings that correspond to the respective housing zones. The battery pack also has tabs connected to the battery cells through the openings in the PCB. A battery management system (BMS) is located on a lateral surface of the casing, in which the PCBs comprise pattern parts and in which: the first ends of the pattern parts of the first PCB are connected to those of the respective tabs corresponding to the first PCB and the second ends of the pattern parts of the first PCB are at a first pattern collection part on the lateral surface of the casing, and the first ends of the pattern parts of the second PCB are connected to those of the respective tabs corresponding to the second PCB and the second ends of the pattern parts of the second PCB are at a second pattern collection part on the lateral surface of the casing.

Document U.S. Pat. No. 10,559,804B2 discloses a battery pack comprising a first and a second group of cells each comprising one or more cells, a printed circuit board electrically connected to the first and second group of cells and a connector provided in the printed circuit board and comprising a plurality of connection terminals. The connection terminals comprise first and second connection terminals respectively connected electrically to the first and second electrodes of the first group of cells. The connection terminals comprise first and second connection terminals respectively connected electrically to the first and second electrodes of the second group of cells. The first and third connection terminals are in removable contact with each other, the second and fourth connection terminals are in removable contact with each other. According to some embodiments, it is possible to simply physically release a parallel connection of a plurality of cells or a plurality of groups of cells.

Document US 2010/062329 A1 discloses a storage battery assembly for vehicles comprising a plurality of battery cells. Each battery cell comprises a closed casing and at least one terminal extending from the casing. Conductive bars, mounted on dedicated terminals, electrically connect the battery cells. At least one printed circuit board comprises electronic circuits configured to at least monitor and control the battery cells. The terminals are equipped with electrically conductive interconnection washers mounted on them. The interconnection washers extend to a dedicated printed circuit board and are connected to the electronic circuits on the respective printed circuit board.

Document GB 2522443 A discloses a battery pack using a printed circuit board as an electrical connection to connect battery cells, comprising a printed circuit board, several conductive parts, protection components, battery cells, and a conductive circuit. The printed circuit board comprises several openings. The conductive parts each comprise a first conductive section electrically connected to the upper surface of the printed circuit board, a middle section abutting against the internal surface of the openings, and a second conductive section inserted through the openings toward the lower surface. The protection components are fixed on the upper surface of the printed circuit board. The battery cells each have two conductive terminals aligned with the openings and are electrically connected to the second conductive section. The conductive circuit is electrically connected between the battery cells, the conductive parts, and between the conductive bases of the protection components, and each battery cell is electrically connected to one of the corresponding protection components. Preferably, the conductive parts are connected to the battery terminals by welding.

Document EP 3 660 952 A1 discloses a battery module comprising: battery cells comprising negative and positive electrodes on the same side; a first conductive plate arranged at the end parts of the battery cells and adjacent to the negative and positive electrodes, the first conductive plate comprising first through holes, through which the negative and positive electrodes are respectively exposed and first stepped parts that are adjacent to the first through holes and recessed toward the battery cells; an insulating plate arranged on the first conductive plate and comprising second through holes that at least partially overlap the first through holes; a second conductive plate arranged on the insulating plate, the second conductive plate comprising third through holes that at least partially overlap the second through holes and second stepped parts that are adjacent to the third through holes and recessed toward the insulating plate; first connection tabs electrically connecting the positive electrodes or negative electrodes to the first stepped parts; and second connection tabs electrically connecting the other positive and negative electrodes to the second stepped parts.

Several problems related to this technology arise and need to be resolved, notably:
the mode of connection of each unit cell with the PCB;
the mechanical attachment of the cells compatible with dismantling the pack and good vibration resistance;
the easy connection of the battery pack with the battery management system (BMS);
the capacity (related to the BMS) to diagnose the state of the cells in a maintenance context;
the necessary size reduction for the connection between the cells and the PCBs of the pack;
the reduction of the space required for attachment of the PCBs of the pack.

### DEFINITIONS

The capacity of a battery is the amount of current continuously supplied by the battery. It is expressed in ampere-hours (Ah). If the capacity of a battery is multiplied by its (nominal) voltage in volts (V), the energy of the battery (in watt-hours, Wh) is obtained. To characterize a battery, the capacity and voltage must therefore be known.

A battery management system (BMS) is an intelligent electronic safety system, particularly intended for the management of battery packs including cells in series and in parallel, able to ensure protection mainly against overvoltage, undervoltage, and overcurrent. In addition to basic functions, the BMS can ensure additional control and management functions such as element balancing, personalized settings, via smartphone and Bluetooth connection, etc.

### SUMMARY

In an embodiment, the present invention provides a rechargeable battery pack, comprising: a plurality of battery cells, each battery cell of the plurality of battery cells having a positive terminal and a negative terminal, an upper surface and a lower surface, the positive and negative terminals being arranged on a same side on the upper or lower surface or alternatively arranged on the upper and lower surface, the plurality of battery cells being arranged in a first direction and in a second direction, orthogonal to the first direction; a mechanical support structure for the battery cells; at least two printed circuit boards for electrical interconnection of the battery cells arranged on the upper surface or the lower surface, or both; means of electrical interconnection by contact and without welding between the battery cells and the printed circuit boards allowing a connection of the battery cells in series and/or in parallel; and means of mechanical attachment of the printed circuit boards to the mechanical support structure, wherein the mechanical support structure comprises a lower plate and an upper plate, both provided with housings in corresponding alignment intended to accommodate and locate without gluing respectively a first end of the battery cells and a second end of the battery cells, wherein the printed circuit boards are identical or have a limited number of sizes according to a number of cell connections they possess, wherein the printed circuit boards have through holes for attachment by means of screws or rivets to the printed circuit boards to the lower plate and the upper plate of the mechanical structure via alignment holes corresponding to the through holes of the printed circuit boards, in the plates, the alignment holes being located between the housings in the lower plate and the upper plate, wherein the means of mechanical attachment cooperates with the printed circuit boards and the mechanical structure to be able to quickly modify a number of battery cells and consequently a total capacity and voltage of the battery pack, wherein the printed circuit boards have a non-linear, wavy profile or side, so that two adjacent printed circuit boards have offset wavy profiles, so that, in a final assembly of the battery pack, two adjacent holes on a straight line along a junction of the two printed circuit boards are alternately positioned on one and the other printed circuit board, and wherein the attachment of the printed circuit boards respectively to the lower plate and the upper plate of the mechanical support structure are located outside the cells.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 represents an embodiment for the connection between the cells and the PCBs in a battery pack according to the invention, with the electrical connections positioned on only one side of a unit cell, at a PCB located on this same side, according to a perspective view (on left) and two elevation views at 90° to each other (on right).

FIG. 2 represents another embodiment for the connection between the cells and the PCBs in a battery pack according to the invention, with electrical connections positioned on both sides of a unit cell, at the two PCBs located respectively on each side of the cell, according to a perspective view (on left) and an elevation view (on right).

FIG. 3 shows, according to a plan view, the space gain obtained in the configuration according to one embodiment of the invention by means of a particular profile of PCBs allowing their interlocking.

FIG. 4 shows another embodiment of a complete battery pack the total capacity of which is defined by 6 cells and the total voltage is defined by 13 cells, as well as its mechanical structure and using PCBs on both sides of the pack.

FIGS. 5A to 5D show the different assembly steps of a battery pack according to the embodiment of FIG. 4, with a bottom-up approach.

FIG. 6 shows an embodiment according to the invention of a simple PCB integrating a standard size fuse per cell and a standard connector intended for the connection of a battery control system BMS.

### DETAILED DESCRIPTION

In an embodiment, the present invention provides a solution that does not require welding on the unit cells, nor the use of glue to bond the cells together, which allows for easy design and realization of new batteries with different and variable capacities and/or voltages, ultimately improving the maintenance of the battery pack as well as its recycling.

In an embodiment, this type of battery pack is usable in/as any type of pack integrating smaller unit cells.

In an embodiment, the batteries according to the invention do not have extremely fast charging constraints, and therefore high thermal constraints.

In an embodiment, the invention provides a rechargeable battery pack comprising:
a plurality of battery cells, each battery cell having a positive terminal and a negative terminal, an upper surface and a lower surface, said positive and negative terminals being arranged on the same side on the upper or lower surface or alternatively arranged on the upper surface and the lower surface, the plurality of battery cells being arranged in a first direction and in a second direction, orthogonal to the first direction;
a mechanical support structure for the battery cells;
at least two printed circuit boards for the electrical interconnection of the battery cells arranged on said upper surface or said lower surface, or both;
means of electrical interconnection by contact and without welding between the battery cells and the printed circuit boards allowing a connection of the battery cells in series and/or in parallel;
means of mechanical attachment of the printed circuit boards to the mechanical support structure;
the mechanical structure comprising a lower plate and an upper plate, both provided with aligned corresponding housings intended to accommodate and locate without gluing respectively a first end of the battery cells and a second end of the battery cells, the printed circuit boards being identical or having a limited number of sizes according to the number of cell connections they possess;
the printed circuit boards having through holes for attaching, by means of screws or rivets, the printed circuit boards to the lower plate and the upper plate of the mechanical structure via alignment holes corresponding to the through holes of the printed circuit boards, in said plates, said corresponding holes being located between said housings in the lower plate and the upper plate;
said means of mechanical attachment cooperating with the printed circuit boards and the mechanical structure to be able to quickly modify the number of battery cells and consequently the total capacity and voltage of the battery pack;
characterized in that:
the printed circuit boards have a profile or lateral non-linear, wavy side, so that two adjacent printed circuit boards have offset wavy profiles, so that, in the final assembly of the battery pack, two adjacent holes on a straight line along the junction of the two printed circuit boards are alternately positioned on one and the other board; and
the fastenings of the printed circuit boards respectively to the lower plate and to the upper plate of the mechanical structure are located outside the cells.

According to preferred embodiments of the invention, the rechargeable battery pack further comprises at least one of the following features or an appropriate combination of several of them:
the printed circuit boards have an identical size or a variable size depending on the number of cell connections they possess;
the housings in the lower plate and the upper plate are generally cylindrical in shape and have a low and high edge respectively to allow the location and blocking of the corresponding battery cell at each of its ends;
the support structures are made of an insulating material, for example, plastic or a conductive material such as metal;
in the case where at least one of the support structures is made of a conductive material, the battery cells, except for their connections, are wrapped in whole or in part in an insulating film, the insulating film stopping if necessary before one end of the cell in order to allow its connection on its periphery;
the support structures are provided with fins on their edge to allow better heat transfer to the outside;
the means of electrical interconnection by contact and without welding comprise connectors or spring contacts;
the printed circuit boards are bus bars;
the rechargeable battery pack comprises an integrated battery management system on one of the printed circuit boards serving as a bus bar or connected to all the printed circuit boards via an edge connector;
the integrated battery management system is configured to know the status of sub-groups of cells;
the integrated battery management system comprises a dedicated circuit to identify a defective cell;
the integrated battery management system is configured to adapt the charging parameters of the battery pack or each sub-group of cells in case of detection of one or more defective unit cells;
a standardized characteristic fuse is associated with each cell, or is in the form of a strip incorporated into the substrate of the printed circuit board or soldered on it, changing the fuse in this latter case requiring the change of the complete board.

The present invention proposes an innovative assembly solution for unit and small-sized battery cells.

The innovation of the solution lies in its flexibility and speed to be able to implement batteries of different capacities and voltages while respecting high safety standards starting from the same standard unit cells. The solution also offers notable advantages in terms of cell recycling and battery maintenance to allow for an increased lifespan of battery packs.

By means of the assembly solution according to the invention, the cells will no longer be welded or glued and the possible individual fuse will be a fuse of standard size and characteristics, preferably a removable cartridge fuse fixed to the PCB on a fuse holder, which can be replaced if necessary by another of the same size but with characteristics corresponding to the unit cells used.

According to the invention, fuses of standardized characteristics can be used that are mounted on a printed circuit board (PCB). These fuses have complete specifications and exist for different current levels allowing the fuse to perfectly match the unit cell used. Alternatively, the fuse can also present the form of a strip incorporated into the PCB substrate or soldered on it, but in this case, changing the fuse will then require changing the complete PCB.

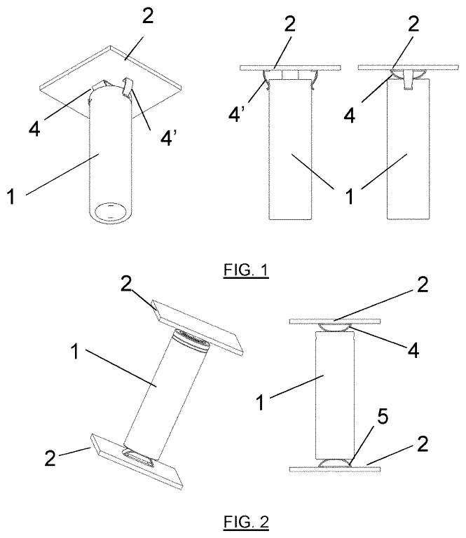

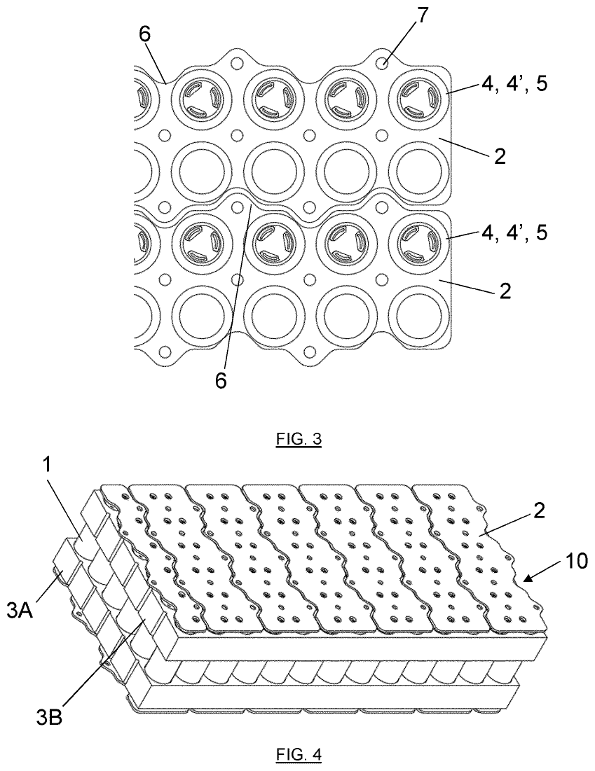

FIG. 1 shows the specific connection of a cell 1 with a single PCB 2, the different polarity connectors 4, 4′ being located on the same side of the cell 1. FIG. 2 shows the specific connection of a cell 1 with two PCBs 2, one of these boards 2 being located on each side of the cell 1. In this case, there is a connector 4 and 5, on each side of the cell 1, the two connections being of opposite polarity. As it is not a question, within the framework of the present invention, to weld the connections to the poles of the individual battery cells, any type of quick contact connector known to the skilled person, for example spring contacts, will be advantageously used. The contact will be made when the PCBs are secured to the mechanical structure of the battery pack (see below).

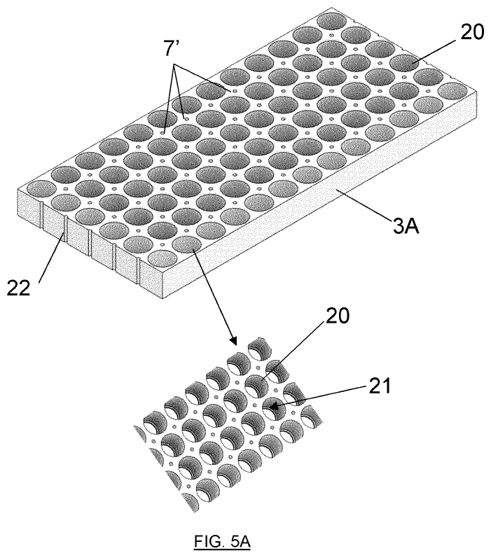

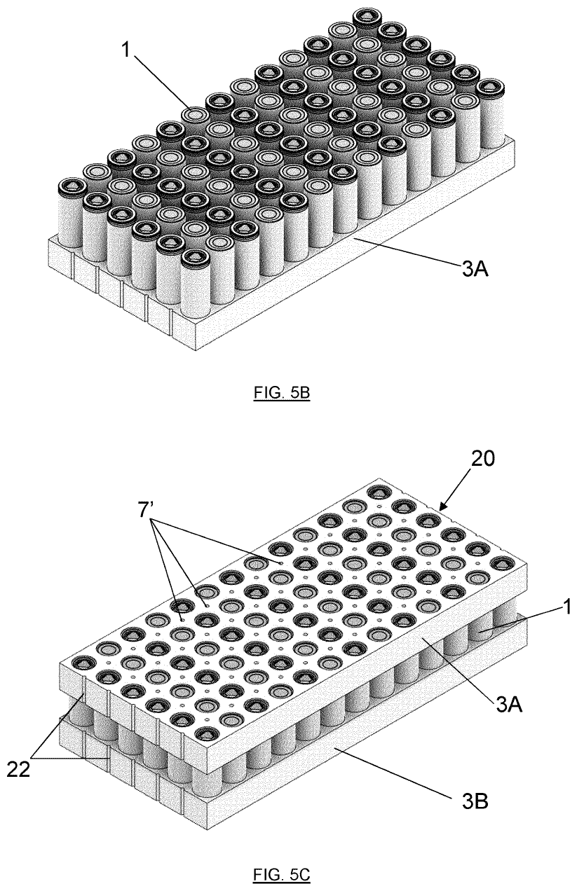

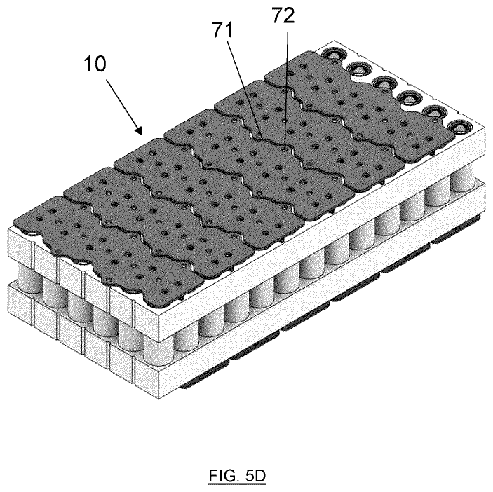

As shown in FIG. 3, a feature of the invention is to propose PCBs 2 having a very particular lateral profile 6, wavy and non-linear, particularly useful when several identical boards 2 are adjacent in the assembly according to this lateral side 6, which provides the advantage of reducing the volume or surface required for the battery pack. The PCBs 2 are provided with through holes 7 to be able to screw these boards to the mechanical structure 3A, 3B of the battery pack (FIG. 4). Since these attachments must necessarily be located outside the cells and in order not to increase the distance between two rows of cells at the place where two PCBs are joined (or adjacent or offset), the wavy profile allows two adjacent holes 71, 72 in the final assembly to be positioned on two different boards 2 (FIG. 5D).

FIG. 4 shows a fully assembled battery pack according to one embodiment of the invention.

As represented in FIGS. 5A to 5D, the assembly is advantageously done according to a bottom-up approach. The individual battery cells 1 are first secured without glue to a first mechanical support structure 3A. This structure 3A has the shape of a plate including spaced rows of housings 20, generally cylindrical in shape (to accommodate “pencil” batteries). The cells are arranged in these housings 20 at one end and blocked by an edge 21 at this same end (FIG. 5A; detail). At their other end a second support structure 3B is arranged on the cells, providing identical housings 20 also with an edge (not represented) to block the cells at their other end. The two support structures 3A, 3B are provided with equidistant through holes 7, located between the cell housings and corresponding on the two plates, in order to be able to attach, preferably screw, the different PCBs 2 that will close the battery pack, on one or both sides (as in FIG. 4) of it. For this purpose, the through holes 7 made in the PCBs 2 allow these boards to be precisely located relative to the support structures 3A, 3B. It is only once the rechargeable battery pack 10 is assembled that the connectors of the PCBs 2 effectively ensure the electrical connection of the battery elements with each other, in parallel or in series.

The mechanical support structures 3A, 3B can be made of an insulating material, for example, plastic or a conductive material such as metal, which provides better cooling. In this latter case, however, there is a constraint of perfect isolation of the battery cells relative to the mechanical support (use of cells “wrapped” in an insulating film). For heat dissipation, the support structures can also be provided with fins or grooves 22 allowing air circulation.

The PCBs advantageously have the function of integrating basic protection of the unit cells, such as a fuse, as well as other potential functions such as a BMS. They also facilitate the dismantling of the battery via the use of non-welded connectors. This configuration, of course, allows the use of PCBs either on only one side of the cells for a positive and negative electrical connection or on both sides for a unique (and opposite) polarity connection on each side of the cells.

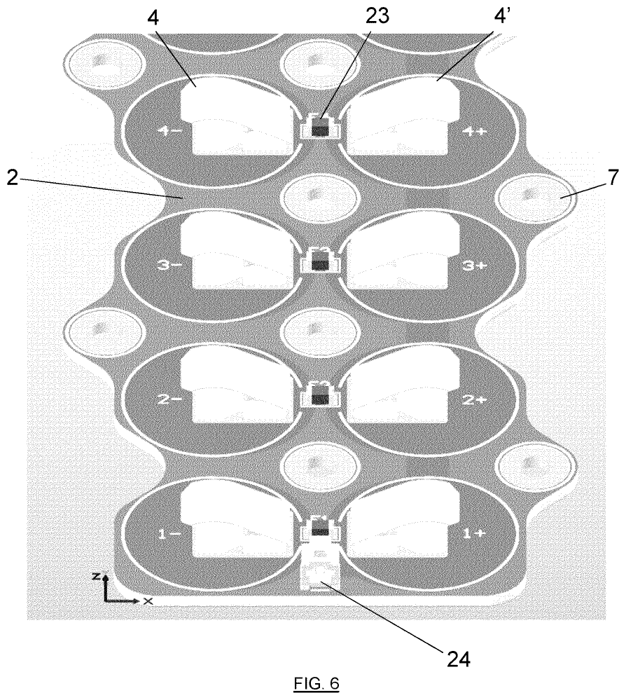

FIG. 6 shows an example of a PCB 2 with four pairs of connectors, respectively corresponding to four cells 1, the board 2 presenting an incorporated fuse 23 per cell, as well as an edge connector 24 for the BMS.

The particular advantages related to the invention are as follows:
the absence of welds facilitates recycling and makes maintenance possible in the case where one or more unit cells are defective;
the attachment of the cells without glue in purely mechanical supports also makes maintenance possible;
the use of PCBs for battery cell connection instead of welded sheets allows design flexibility and makes it possible to directly integrate a BMS or integrate other electronic circuits into the battery (for maintenance or to detect dead cells, for example);
by means of the use of PCBs, battery control can be carried out to the “set” or subset level (level with 6 unit cells, for example) with the possibility of determining the status of each “set”;
the status of each “set” being known, the battery management system (BMS) can be designed to intelligently adapt the charging parameters in order to avoid damaging the cells;
the possibility of integrating the BMS into the battery pack on one of the bus bar boards or on the side of the battery pack via the edge connectors, known in themselves to the skilled person;
the use of standard fuses, which provides flexibility in the choice of cells and independence of the production line relative to the particular cells chosen in each case;
when the fuse is integrated into the PCB, it retains its physical integrity even once electrically open (burned, broken), unlike a simple wire that can leave residue in the battery pack;
the use of PCBs for the connection between the battery cells allows the dangers of short-circuiting during assembly to be reduced, since the conductive elements are isolated from the external surface of the PCBs and all connections are then established at the same time. On the other hand, in the case of bus bars, it is easier to establish a short circuit during assembly than with a PCB system;
the battery output connectors as well as the connectors for a BMS not integrated into the PCB can directly be part of the PCB;
as the final assembly does not comprise a welding step but only mechanical assembly steps, there is therefore no need to have specifically qualified personnel for welding the cells or to have a dedicated machine. This avoids the risk of damaging the cells during assembly by welding.

The disadvantages of the invention are only related to certain higher costs (but which are largely offset by the technological and operational advantages):
the use of a PCB instead of a welded sheet generates a higher cost compared to direct welding for large battery packs (typically with more than 100 cells per pack);
the use of standard fuses generates a higher cost relative to a simple wire (or a simple tab) welded when the production volume is large.

The battery pack according to the present invention is particularly suitable for military vehicle applications or industrial applications, in which, unlike civilian vehicles, the charging speed constraint and therefore the corresponding thermal constraint may not be very important.

Energy storage applications such as domestic batteries (power wall) with larger cells and constituting a mix of scalable and extensible sub-modules according to the invention and welded sub-modules can also be considered, as long as the degree of maintainability of the whole is deemed sufficient.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.
1 battery cell
2 printed circuit board
3A, 3B mechanical support structure
4, 4′ connector
5 connector
6 wavy profile of printed circuit board
7, 7′ through hole (resp. non-through)
10 rechargeable battery pack
20 housing in mechanical support plate
21 housing edge
22 groove
23 Fuse
24 edge connector
71, 72 adjacent holes in final assembly

1. A rechargeable battery pack, comprising:
a plurality of battery cells each battery cell of the plurality of battery cells having a positive terminal and a negative terminal, an upper surface and a lower surface, the positive and negative terminals being arranged on a same side on the upper or lower surface or alternatively arranged on the upper and lower surface, the plurality of battery cells being arranged in a first direction and in a second direction, orthogonal to the first direction;
a mechanical support structure for the battery cells;
at least two printed circuit boards for electrical interconnection of the battery cells arranged on the upper surface or the lower surface, or both;
means of electrical interconnection by contact and without welding between the battery cells and the printed circuit boards allowing a connection of the battery cells in series and/or in parallel; and
means of mechanical attachment of the printed circuit boards to the mechanical support structure;
wherein the mechanical support structure comprises a lower plate and an upper plate, both provided with housings in corresponding alignment intended to accommodate and locate without gluing respectively a first end of the battery cells and a second end of the battery cells,
wherein the printed circuit boards are identical or have a limited number of sizes according to a number of cell connections they possess,
wherein the printed circuit boards have through holes for attachment by means of screws or rivets to the printed circuit boards to the lower plate and the upper plate of the mechanical structure via alignment holes corresponding to the through holes of the printed circuit boards in the plates, the alignment holes being located between the housings in the lower plate and the upper plate,
wherein the means of mechanical attachment cooperates with the printed circuit boards and the mechanical structure to be able to quickly modify a number of battery cells and consequently a total capacity and voltage of the battery pack,
wherein:
the printed circuit boards have a non-linear, wavy profile or side, so that two adjacent printed circuit boards have offset wavy profiles, so that, in a final assembly of the battery pack, two adjacent holes on a straight line along a junction of the two printed circuit boards are alternately positioned on one and the other printed circuit board, and
wherein the attachment of the printed circuit boards respectively to the lower plate and the upper plate of the mechanical support structure are located outside the cells.

2. The rechargeable battery pack of claim 1, wherein the printed circuit boards have an identical size or a variable size depending on the number of cell connections they have.

3. The rechargeable battery pack of claim 1, wherein the housings in the lower plate and the upper plate are generally cylindrical in shape and have a housing edge respectively low and high to allow the location and blocking of the corresponding battery cell at each of its ends.

4. The rechargeable battery pack of claim 1, wherein the mechanical support structures comprise an insulating material or a conductive material.

5. The rechargeable battery pack of claim 4, wherein, in a case where at least one of the support structures comprises a conductive material, the battery cells, except for their connections, are wrapped in whole or in part in an insulating film, the insulating film stopping if necessary before one end of the cell to allow its connection on its periphery.

6. The rechargeable battery pack of claim 1, wherein the support structures are provided with fins on their edge to allow enhanced heat transfer to an outside.

7. The rechargeable battery pack of claim 1, wherein the means of electrical interconnection by contact and without welding include the connectors or spring contacts.

8. The rechargeable battery pack of claim 1, wherein the printed circuit boards are bus bars.

9. The rechargeable battery pack of claim 8, further comprising:
an integrated battery management system on one of the printed circuit boards serving as a bus bar or connected to all the printed circuit boards via an edge connector.

10. The rechargeable battery pack of claim 9, wherein the integrated battery management system is configured to know the status of the sub-groups of the battery cells.

11. The rechargeable battery pack of claim 11, wherein the integrated battery management system comprises a dedicated circuit to identify a defective battery cell.

12. The rechargeable battery pack of claim 9, wherein the integrated battery management system is configured to adapt charging parameters of the rechargeable battery pack or each sub-group of battery cells in case of detection of one or more defective unit cells.

13. The rechargeable battery pack of claim 1, wherein a standardized characteristic fuse is associated with each cell, or is in a form of a strip incorporated into the substrate of the printed circuit board or soldered on it, changing the fuse in this latter case requiring the change of the complete printed circuit board.

14. The rechargeable battery pack of claim 4, wherein the insulating material comprises plastic and/or the conductive material comprises metal.
